(19) United States
(12) Patent Application Publication
(10) Pub. No.: US 2026/0149788 A1
(43) Pub. Date: May 28, 2026

(54) RECORDING APPARATUS

(71) Applicant: TOYOTA JIDOSHA KABUSHIKA KAISHA, Toyota-shi (JP)

(72) Inventor: Takumi FUKUNAGA, Iwakura-shi (JP)

(73) Assignee: TOYOTA JIDOSHA KABUSHIKA KAISHA, Toyota-shi (JP)

(21) Appl. No.: 19/380,985

(22) Filed: Nov. 6, 2025

(30) Foreign Application Priority Data
Nov. 25, 2024 (JP) 2024-204996

(51) Int. Cl. H04N 5/77; H04N 5/92; H04N 7/18

(52) U.S. Cl. CPC H04N 5/77; H04N 5/9201; H04N 7/188

(57) ABSTRACT

A recording apparatus includes a first controller configured to control an imaging device provided in a vehicle, a second controller activated by the first controller and configured to perform control of storing, in a recording unit, an image captured by the imaging device. The recording apparatus includes a memory configured to temporarily record the image, and the first controller is configured to be able to perform cyclic recording in which the image captured by the imaging device is sequentially recorded in the memory and the image in order starting with an old image is overwritten and recorded when capacity of the memory is reached.

### CROSS-REFERENCE TO RELATED APPLICATION

This application claims priority to Japanese Patent Application No. 2024-204996 filed on November 25, 2024. The disclosure of the above-identified application, including the specification, drawings, and claims, is incorporated by reference herein in its entirety.

### BACKGROUND

### 1. Technical Field

The present disclosure relates to a recording apparatus.

### 2. Description of Related Art

Japanese Unexamined Patent Application Publication No. 2023-121886 (JP 2023-121886 A) discloses a system including a function of turning on power of a camera based on detection of movement of an object, and then starting recording of a video from the camera in a case where the movement of the object is detected after a time that is predetermined has elapsed.

### SUMMARY

In a recording apparatus such as a drive recorder mounted in a vehicle, cyclic recording is performed to record an image before an event such as approach of an object is detected. In the cyclic recording, new data is overwritten on old data to always record the latest image.

In order to perform the cyclic recording, a recording function needs to be constantly activated. Therefore, battery consumption of the vehicle increases.

The present disclosure can reduce the battery consumption of the vehicle.

According to an embodiment of the present disclosure, there is provided a recording apparatus including:

a first controller configured to control an imaging device provided in a vehicle;

a second controller activated by the first controller and performing control of storing, in a recording unit, an image captured by the imaging device; and

a memory configured to temporarily record the image,

in which the first controller is configured to be able to perform cyclic recording in which the image captured by the imaging device is sequentially recorded in the memory, and the image in order starting with an old image is overwritten and recorded when capacity of the memory is reached.

According to the present disclosure, it is possible to reduce battery consumption of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a recording apparatus according to an embodiment of the present disclosure; and

FIG. 2 is a flowchart showing operation of the recording apparatus according to the embodiment of the present disclosure.

### DETAILED DESCRIPTION OF EMBODIMENTS

Hereinafter, embodiments of the present disclosure will be described with reference to drawings.

In each of the drawings, the same or corresponding parts are designated by the same reference numerals. In the description of the present embodiment, the description of the same or corresponding parts will be omitted or simplified as appropriate.

A recording apparatus such as a drive recorder mounted in a vehicle has a function of detecting occurrence of an event, such as receiving an impact or an object like a person approaching, and recording an image in a case where the vehicle is parked. With the function, it is possible to objectively identify a situation such as either or both of a traffic accident and vandalism against the vehicle. In addition, the image information that plays an important role in assisting problem solving is provided as evidence to, for example, an institution such as an insurance company or a police force. In problem solving, in a case where the event is detected, an image before event detection needs to be recorded and a situation needs to be sufficiently described. As a technique for recording the image before the event detection, for example, cyclic recording is considered. The cyclic recording is to perform so-called cyclic recording in which the image that is captured is sequentially recorded in the recording apparatus and a new image in order starting with an old image is overwritten and recorded when the recording apparatus reaches a storage capacity that is predetermined. The cyclic recording has a loop function, and in a case where recording data exceeds the storage capacity, the recording data is overwritten (erased) from the old data. Therefore, the latest image for a constant time is always stored.

Functions in the drive recorder are divided into domains, and the domains are controlled by a domain controller. The domain controller is a system that integrates and efficiently manages a plurality of ECUs in the vehicle. The "ECU" is an abbreviation for an electronic control unit. The domain controller controls various resources in the same domain. In the drive recorder, for example, a camera domain controller that has a role of acquiring image data and a drive recorder domain controller that has a large-capacity memory and stores video data are present. The cyclic recording is controlled by the drive recorder domain controller. Therefore, in order to store the video before the event detection, not only the camera domain controller but also the drive recorder domain controller is constantly activated to store the video captured by the cyclic recording.

In a case where the drive recorder domain controller is constantly activated, battery consumption of the vehicle increases. That is, since the drive recorder domain controller is constantly activated even when the event does not occur, waste of power consumption occurs. In a case where the battery consumption increases, an operating time of the vehicle is shortened. Therefore, there is room for improvement in reducing the battery consumption of the vehicle.

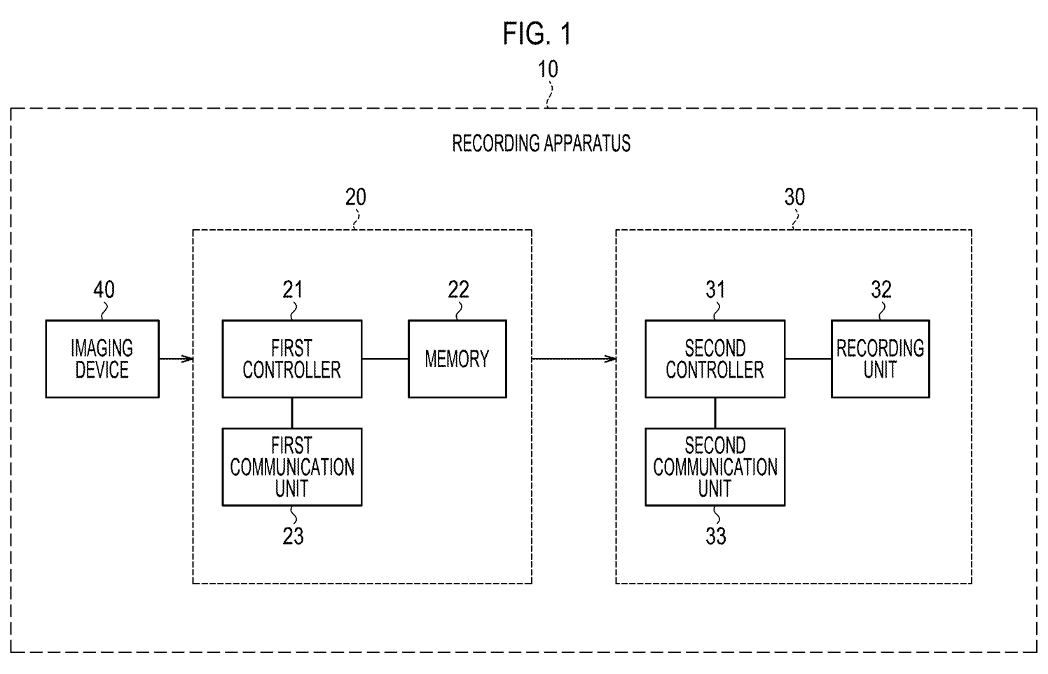

An outline of a recording apparatus 10 according to an embodiment of the present disclosure will be described with reference to FIG. 1.

In the present embodiment, the recording apparatus 10 is a drive recorder. The recording apparatus 10 includes a first domain 20 and a second domain 30.

The first domain 20 is controlled by a so-called camera domain controller. The first domain 20 includes a first controller 21 as the camera domain controller, a memory 22 configured to temporarily record the image, and a first communication unit 23. The first controller 21 controls an imaging device 40 provided in the vehicle. In the present embodiment, the imaging device 40 is an in-vehicle camera system mounted in the vehicle. The first controller 21 sequentially records the image captured by the imaging device 40 in the memory 22, and overwrites and records the image in order starting with the old image when capacity of the memory 22 is reached. In the present embodiment, the image includes a video.

The second domain 30 is controlled by a so-called drive recorder domain controller. The second domain 30 includes a second controller 31 as the drive recorder domain controller, a recording unit 32 that stores the image captured by the imaging device 40, and a second communication unit 33. The second controller 31 is controlled based on a command of the first controller 21. The second controller 31 is activated by the first controller 21 to perform control of storing the image captured by the imaging device 40 in the recording unit 32.

In FIG. 1, a flow of image data from the imaging device 40 to the first domain 20 and a flow of image data from the first domain 20 to the second domain 30 are indicated by arrows.

According to the present embodiment, the recording apparatus 10 includes the first controller 21 activating the imaging device 40 that captures an image of a periphery when the vehicle is parked, and the second controller 31 activated by the first controller 21 and configured to record the video captured by the imaging device 40. By separating activation timings of the first controller 21 and the second controller 31, activation timings of the first domain 20 and the second domain 30 can be made different from each other. As a result, solely the power needed for each of the domains is used. That is, even in a case where a cyclic recording function is activated in the first domain 20 by the first controller 21, the second controller 31 can be temporarily stopped and put into a so-called sleep state. Therefore, power consumption in the second domain 30 can be suppressed while the cyclic recording function is used. Therefore, the battery consumption of the vehicle can be reduced.

Each configuration of the recording apparatus 10 will be described in detail with reference to FIG. 1.

As shown in FIG. 1, the recording apparatus 10 includes the first domain 20, the second domain 30, and the imaging device 40. The first domain 20 includes the first controller 21, the memory 22, and the first communication unit 23. The second domain 30 includes the second controller 31, the recording unit 32, and the second communication unit 33.

The first controller 21 and the second controller 31 include at least one processor, at least one programmable circuit, at least one dedicated circuit, or any combination thereof, and execute processing that is predetermined.

The memory 22 is a temporary storage medium used for the cyclic recording. The memory 22 temporarily stores data and overwrites old data after a certain period to always store the latest data. The memory 22 is, for example, a volatile memory such as DRAM. The "DRAM" is an abbreviation for a dynamic random access memory.

The recording unit 32 is controlled by the second controller 31 to store the image captured by the imaging device 40. The recording unit 32 includes at least one semiconductor memory, at least one magnetic memory, at least one optical memory, or any combination thereof.

The first communication unit 23 and the second communication unit 33 include at least one communication interface. The first communication unit 23 receives data used for operation of the imaging device 40 and transmits data obtained by the operation of the imaging device 40. In the present embodiment, the first communication unit 23 performs communication with the second communication unit 33. In addition, the imaging device 40 performs communication with either or both of the first communication unit 23 and the second communication unit 33. The communication can be performed using any communication protocol such as a CAN bus, Wi-Fi (registered trademark), or Bluetooth (registered trademark). The "CAN" is an abbreviation for a controller area network.

A function of the recording apparatus 10 is realized by executing a program according to the present embodiment by a processor as either or both of the first controller 21 and the second controller 31. That is, the function of the recording apparatus 10 is realized by software. The program causes a computer to execute operation of the recording apparatus 10, thereby causing the computer to function as the recording apparatus 10. That is, the computer executes the operation of the recording apparatus 10 in accordance with the program to function as the recording apparatus 10.

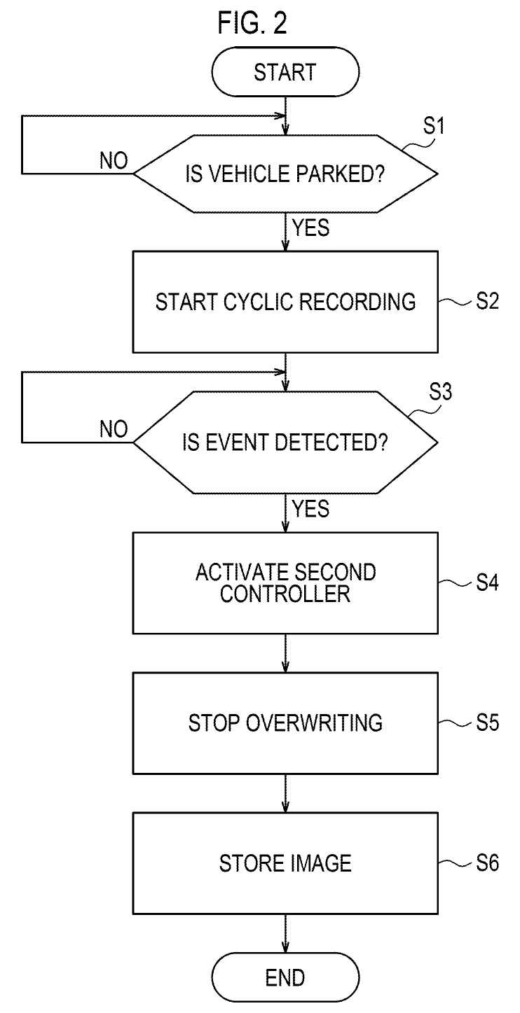

Operation of the recording apparatus 10 according to the present embodiment will be described with reference to FIG. 2. The operation corresponds to a recording method according to the present embodiment. That is, the recording method according to the present embodiment includes steps S1 to S6 shown in FIG. 2. Hereinafter, each of the steps of a flowchart is specified by S and a number.

In S1, the first controller 21 of the recording apparatus 10 determines whether the vehicle is parked based on information from the vehicle. The determination of whether the vehicle is parked can be performed by any procedure, and is performed by, for example, the following procedure. The first controller 21 can determine whether the vehicle is parked by acquiring speed data of the vehicle from a vehicle speed sensor installed in the vehicle. The processing of S1 is repeated until it is determined that the vehicle is parked. In a case where it is determined in S1 that the vehicle is parked, the processing of S2 is performed.

In S2, the first controller 21 of the recording apparatus 10 controls the imaging device 40 to capture an image of a periphery of the vehicle. In addition, the first controller 21 controls the second controller 31 to set the second controller 31 to a sleep state. The imaging device 40 captures an image of an area (front, rear, side, or top) around the vehicle as the image of the periphery of the vehicle. As the imaging device 40, a drone or the like provided outside the recording apparatus 10 may be used to capture the entirety of the image of the vehicle from a viewpoint at a high place. The first controller 21 can perform so-called cyclic recording of sequentially recording the images captured by the imaging device 40 in the memory 22 and overwriting and recording the images in order starting with the old image when the capacity of the memory 22 is reached. The cyclic recording can be constantly activated, but it is desirable that the first controller 21 starts the cyclic recording in a case where the vehicle VH is detected to be parked. A period recorded as the cyclic recording can be set to any period (for example, 60 seconds) in accordance with the memory capacity. The first controller 21 sequentially overwrites the oldest files in the memory 22 to new data by using the image data acquired from the imaging device 40. By the process, the memory 22 always stores the latest image for a certain period.

In S3, the first controller 21 of the recording apparatus 10 detects whether an event has occurred based on information from a sensor provided in the vehicle. In the present embodiment, the first controller 21 detects an object approaching the vehicle or an impact applied to the vehicle as the event. The event may be detected by any procedure, and is detected by, for example, the following procedure. The first controller 21 acquires sensor data from various sensors installed in the vehicle. The sensor data is, for example, data acquired in real time from a distance sensor, an acceleration sensor, an impact sensor, and the like. The first controller 21 analyzes the sensor data that is acquired and determines that the event has occurred in a case where a specific condition is satisfied, based on an analysis result. For example, in a case where an object is detected within a certain distance by the distance sensor or in a case where the impact detected by the acceleration sensor exceeds a threshold that is set, the first controller 21 determines that the event has occurred. The processing of S3 is repeated at a certain interval until it is determined that the event has occurred. In S3, in a case where it is determined that the event has occurred, the processing of S4 is performed.

In S4, the first controller 21 of the recording apparatus 10 activates the second controller 31 in the sleep state. Specifically, the first controller 21 transmits an activation signal to the second controller 31 via the first communication unit 23. The second controller 31 receives the activation signal transmitted from the first controller 21 via the second communication unit 33.

In S5, the first controller 21 of the recording apparatus 10 stops the overwriting of the image to the memory 22. Overwriting is stopped to protect data captured at the time of the event and to prevent important video from being erased by overwriting.

In S6, the second controller 31 of the recording apparatus 10 stores the image captured by the imaging device 40 in the recording unit 32. Specifically, in a case where the second controller 31 is activated in S4, the second controller 31 receives the image captured by the imaging device 40 from the point in time and starts recording the received image in the recording unit 32. Meanwhile, the second controller 31 acquires, from the first domain 20, the image already captured by the imaging device 40 before the activation. Specifically, the second controller 31 communicates with the first controller 21 via the second communication unit 33 and acquires image data stored in the memory 22 until the second controller 31 is activated. The image data stored in the memory 22 may be recorded and stored separately from the image data after the second controller 31 is activated. It is desirable that the image data stored in the memory 22 is, by the data processing, integrated with initial portions of the image data recorded after the second controller 31 is activated. As a result, the image stored in the recording unit 32 is a series of image data including images before and after the event detection.

In the present embodiment, the second controller 31 may add, as additional information, either or both of a date and a time at which an image captured by the imaging device 40 was taken to the image and store the image in the recording unit 32. In addition, a voice input device may be provided in the recording apparatus 10, and the second controller 31 may store the image captured by the imaging device 40 in the recording unit 32 by adding, as additional information, a voice input from the voice input device at a time at which the image is captured.

According to the present embodiment, it is possible to suppress power consumption of the recording apparatus 10 while using the cyclic recording function of storing the video before and after the occurrence of the event. As a result, it is possible to reduce the battery consumption of the vehicle.

The present disclosure is not limited to the above-described embodiment. For example, a plurality of blocks shown in the block diagram may be integrated, or one block may be divided. Instead of executing a plurality of steps described in the flowchart in time series in accordance with the description, the steps may be executed in parallel or in a different order in accordance with processing capability of a device that executes each step or as necessary. Other modifications without departing from the scope of the present disclosure can also be made.

What is claimed is:

1. A recording apparatus comprising:
a first controller configured to control an imaging device provided in a vehicle;
a second controller activated by the first controller and configured to perform control of storing, in a recording unit, an image captured by the imaging device; and
a memory configured to temporarily record the image,
wherein the first controller is configured to be able to perform cyclic recording in which the image captured by the imaging device is sequentially recorded in the memory and the image in order starting with an old image is overwritten and recorded when capacity of the memory is reached.

2. The recording apparatus according to claim 1, wherein:
the first controller is configured to start the cyclic recording in a case where the first controller detects that the vehicle is parked based on information from the vehicle; and
the first controller is configured to detect occurrence of an event based on information from a sensor provided in the vehicle, after activating the imaging device, to activate the second controller, and to stop the overwriting of the image to the memory when the occurrence of the event is detected.

3. The recording apparatus according to claim 2, wherein the first controller is configured to detect an object approaching the vehicle or an impact applied to the vehicle as the event.

4. The recording apparatus according to claim 1, wherein the second controller is configured to add, as additional information, either or both of a date and a time at which the image is captured by the imaging device to the image, and to store the image in the recording unit.

5. The recording apparatus according to claim 1, further comprising a voice input device,
wherein the second controller is configured to add, as additional information, a voice input from the voice input device at a time at which the image is captured by the imaging device to the image, and to store the image in the recording unit.
